(19) United States
(12) Patent Application Publication
(10) Pub. No.: US 2018/0046720 A1
(43) Pub. Date: Feb. 15, 2018

(54) XoomDat, real-time search and analytics information system

(71) Applicant: Ousmane Conde, Long Beach, CA (US)

(72) Inventor: Ousmane Conde, Long Beach, CA (US)

(21) Appl. No.: 15/429,695

(22) Filed: Feb. 10, 2017

Related U.S. Application Data
(60) Provisional application No. 62/295,140, filed on Feb. 14, 2016.

(51) Int. Cl. G06F 17/30

(52) U.S. Cl. CPC G06F 17/30867; G06F 17/30321

(57) ABSTRACT

The challenge of efficient and meaningful real-time search today for small, medium, and large businesses, is that today's offerings are a one-size-fits-all solution and not readily customizable to meet dynamic business requirements. Because of this challenge, most companies are unable to adapt their search and analytics information systems to their business' growth and change in direction. Solutions currently available (Google Enterprise, Algolia, Search Technologies) require their customers to hire senior developers to build and maintain their end solutions, at the customer's expense. In addition, their security feature offerings are very limited and extremely expensive to tailor, with no “out of the box” customizable capabilities. This, is a problem. As a business grows or changes direction, so should their search, analytics, and intelligence platforms; all while reducing the cost of upgrading and ongoing support.

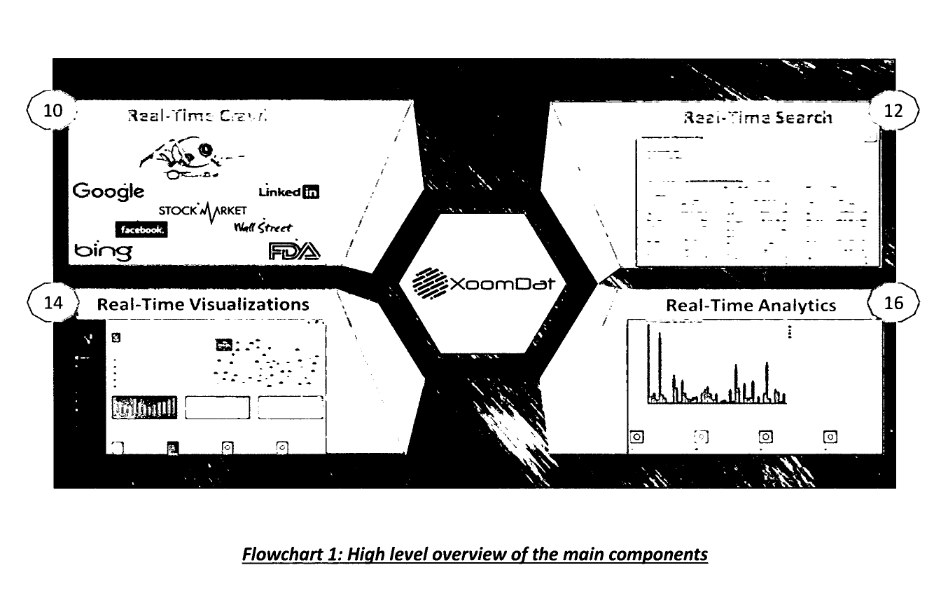

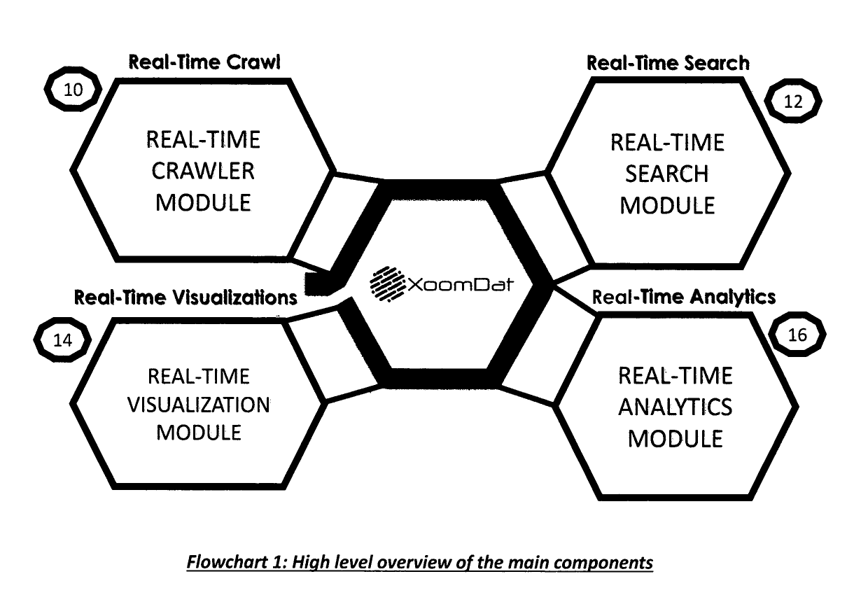

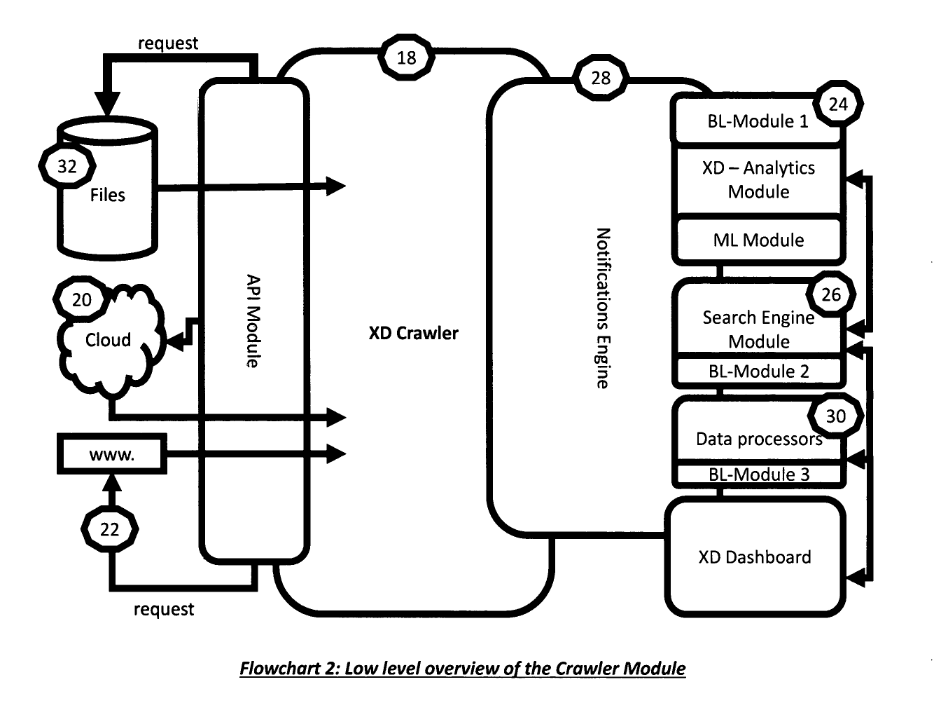

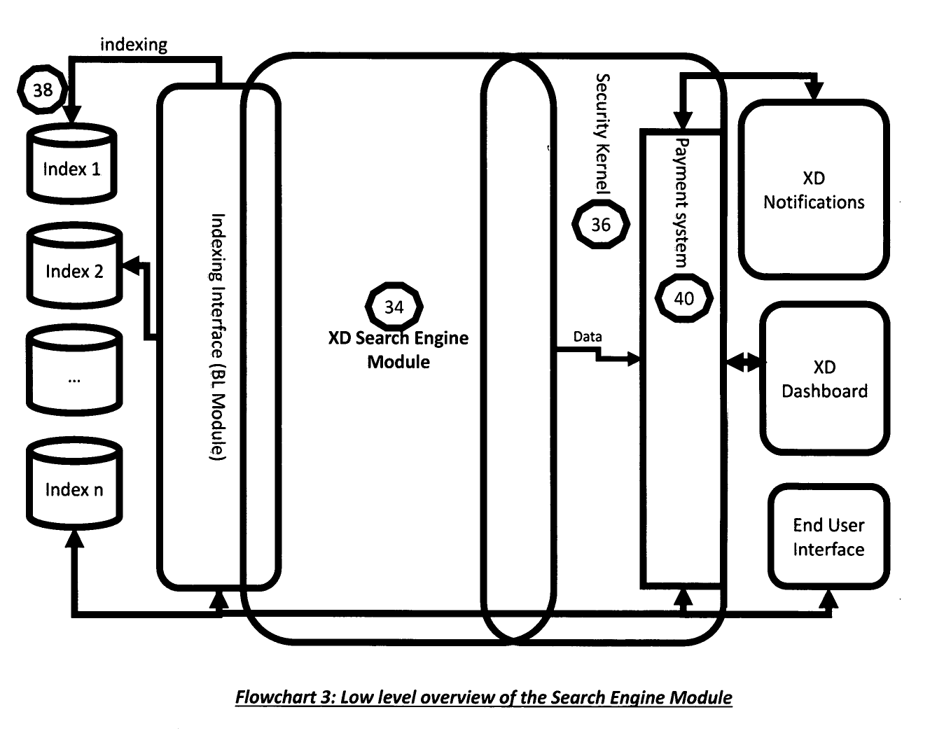

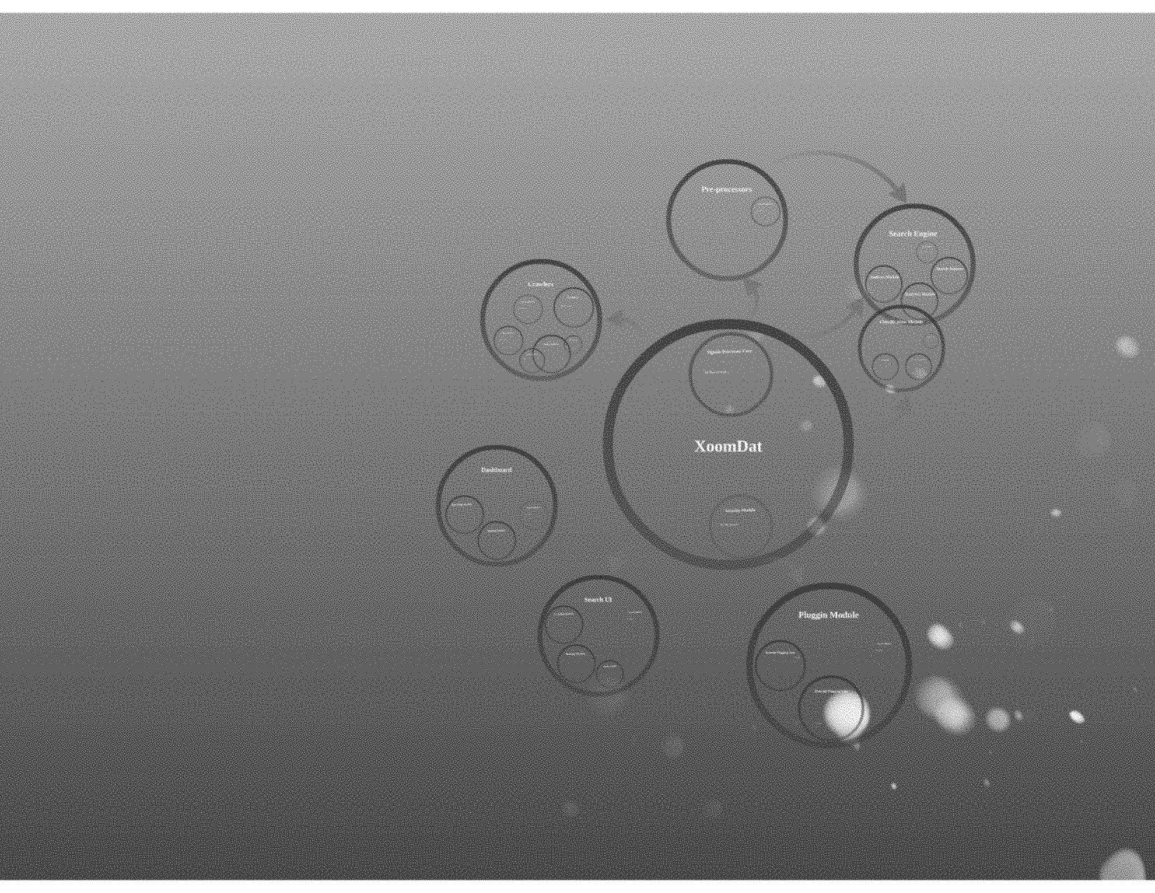

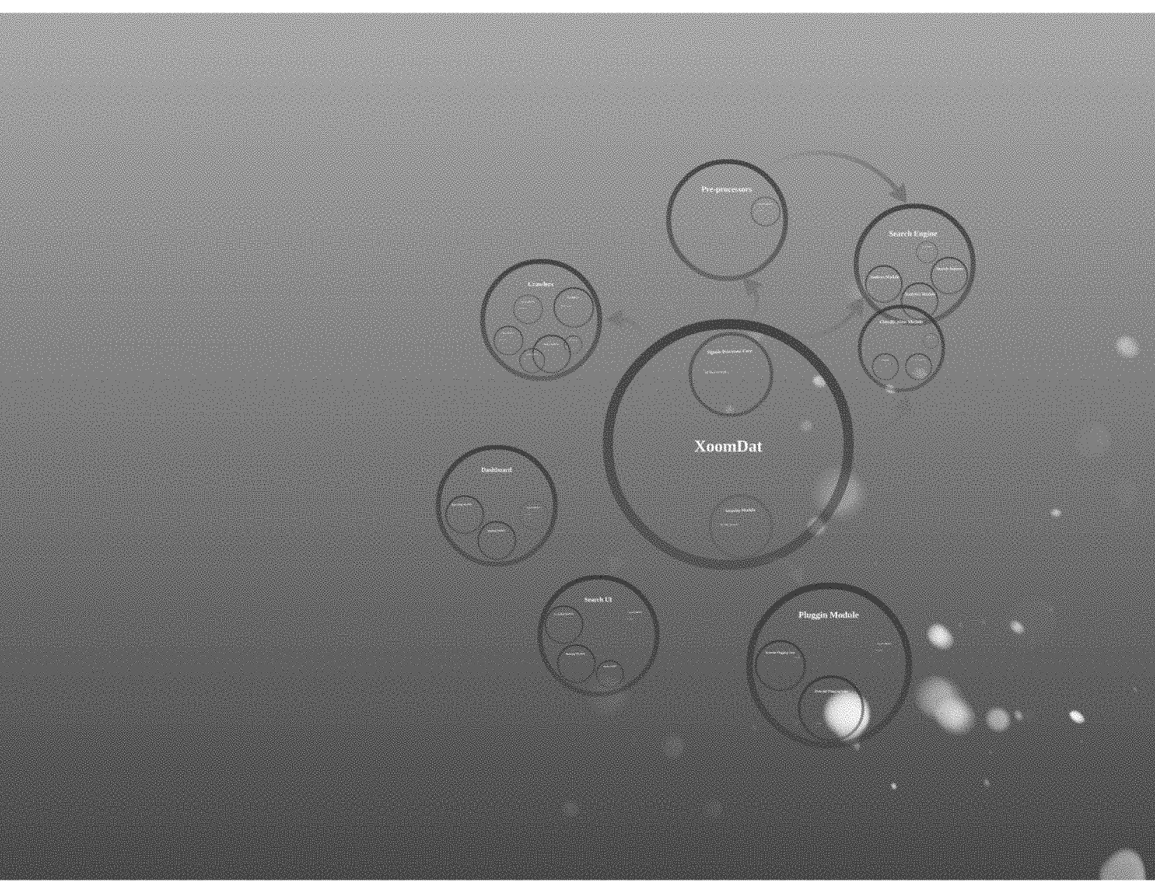

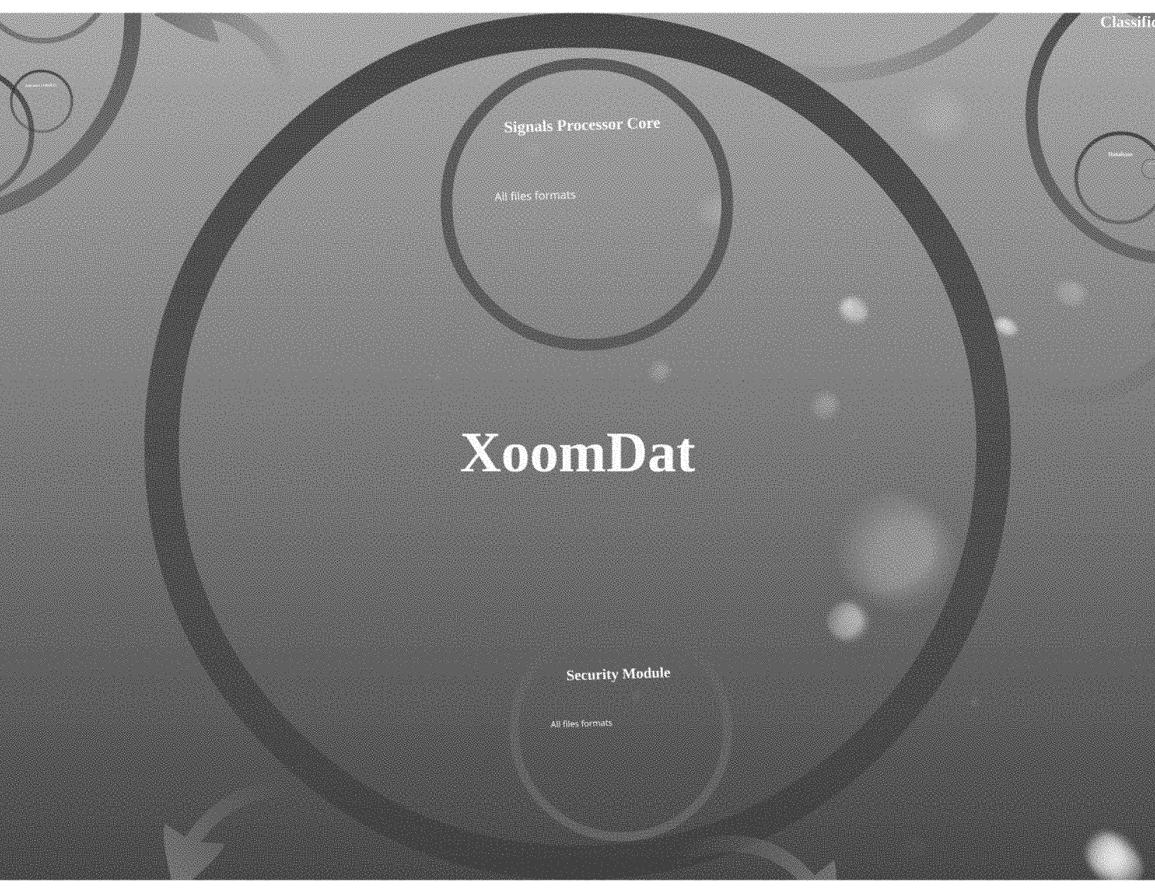

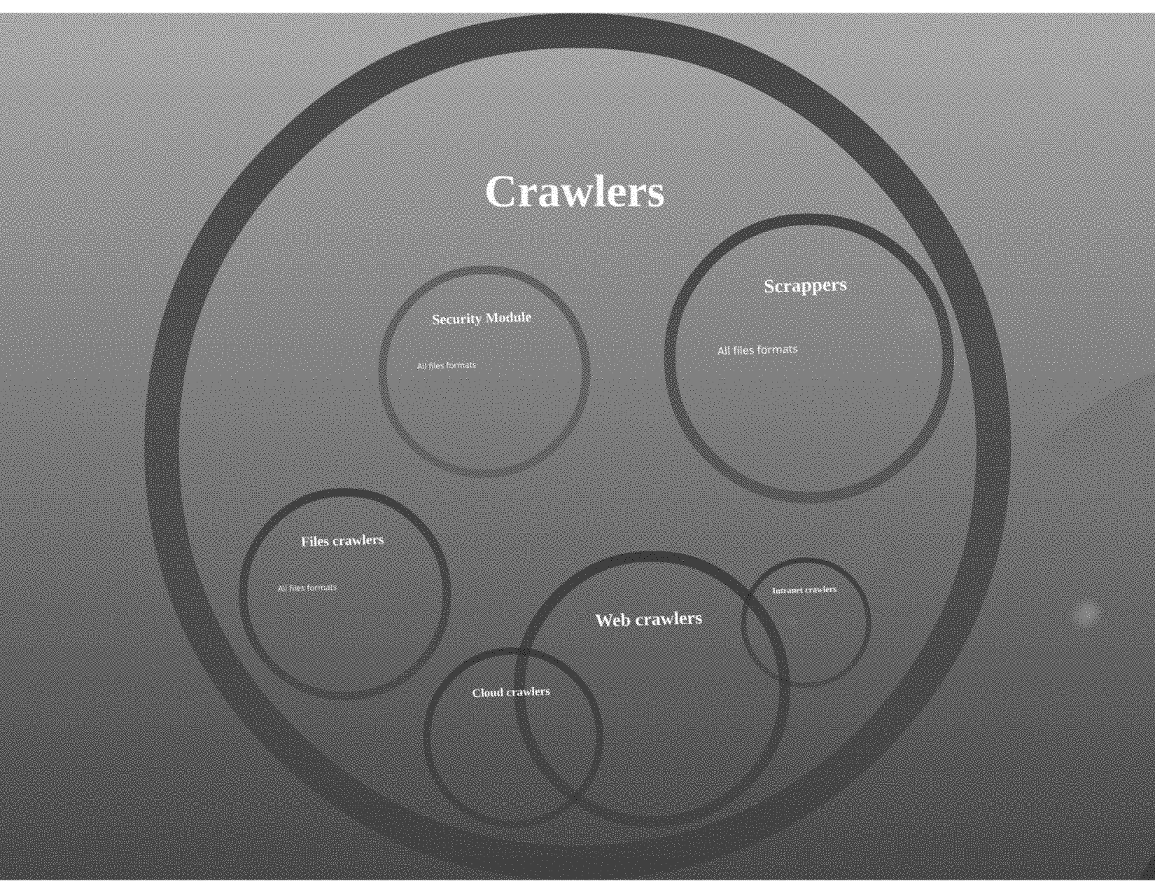

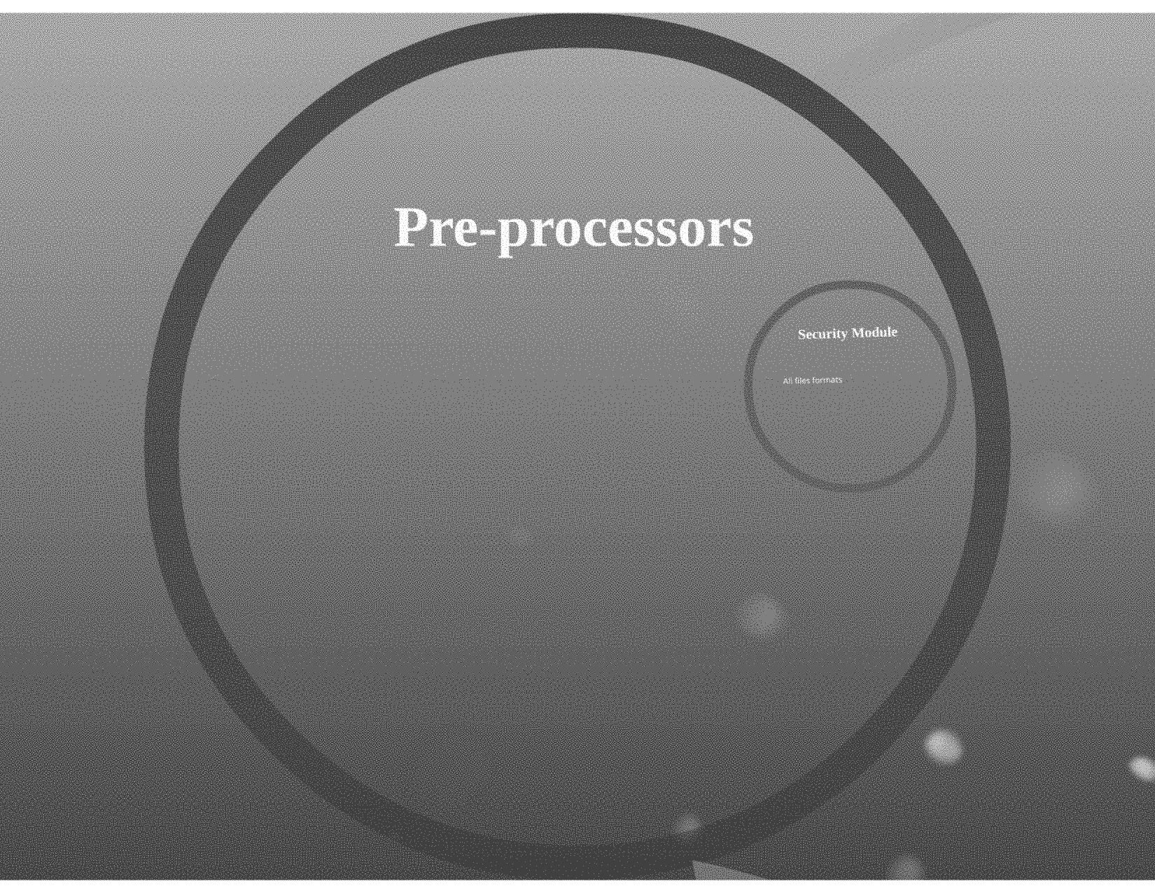

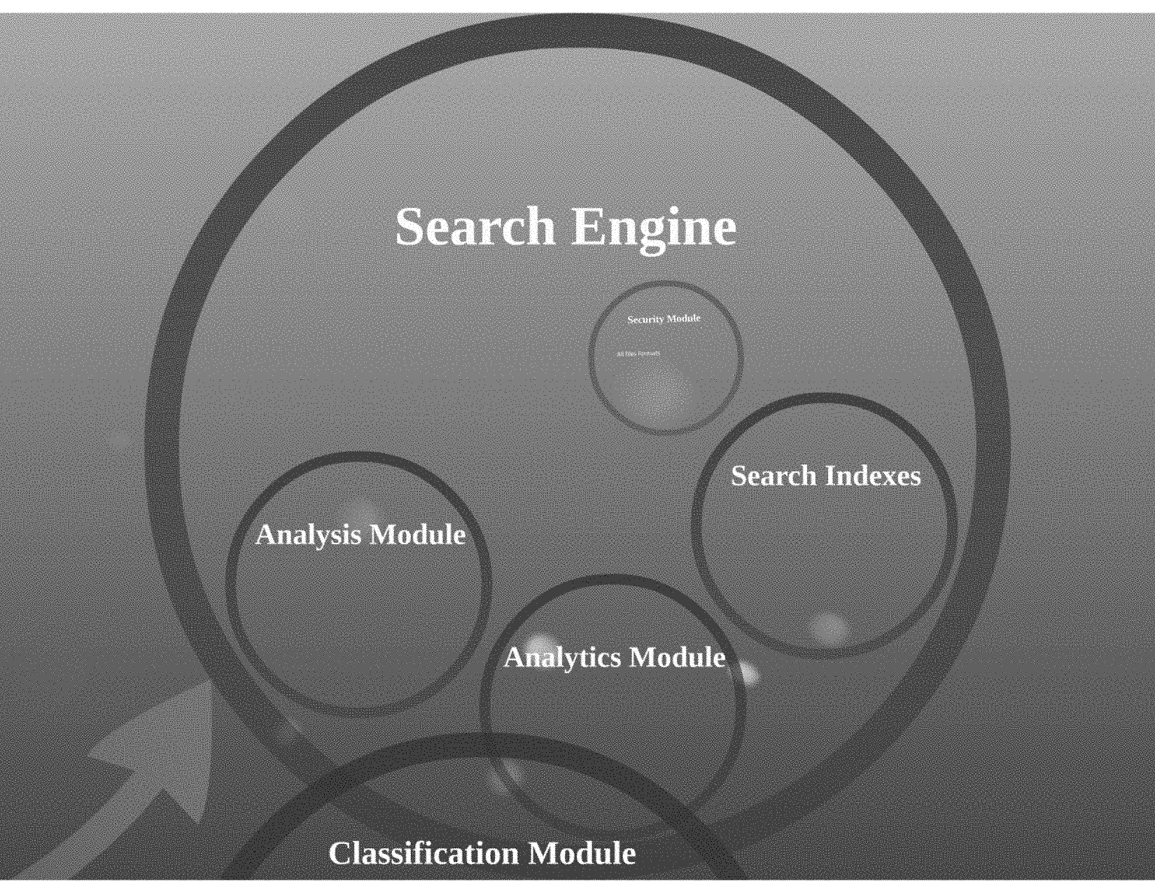

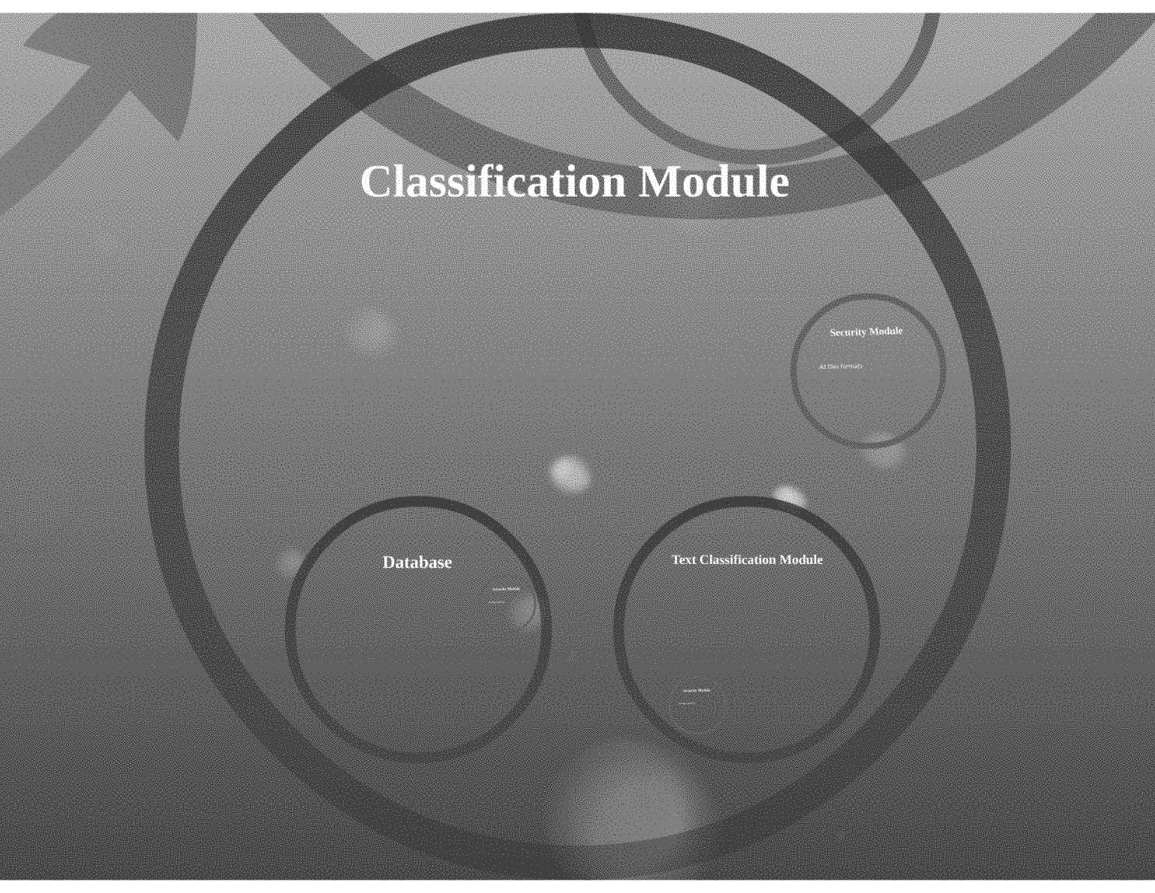

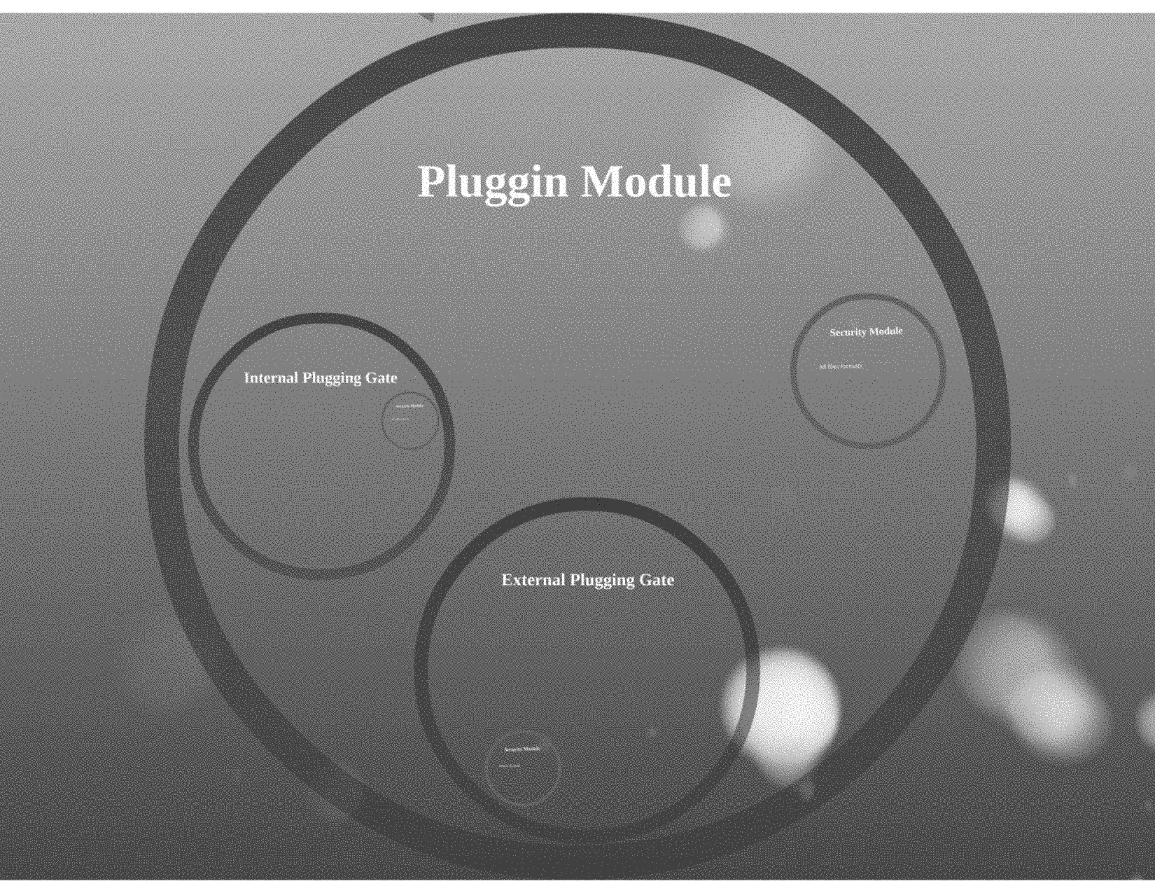

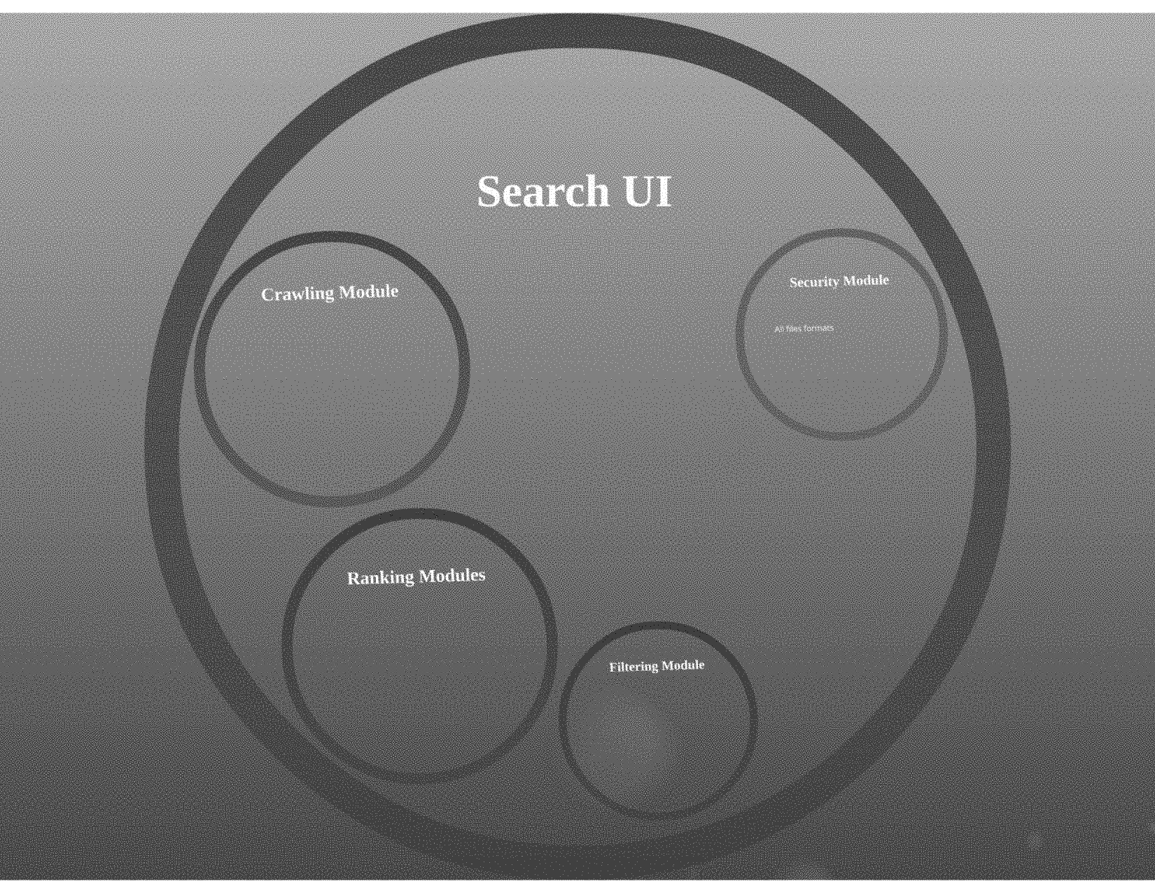

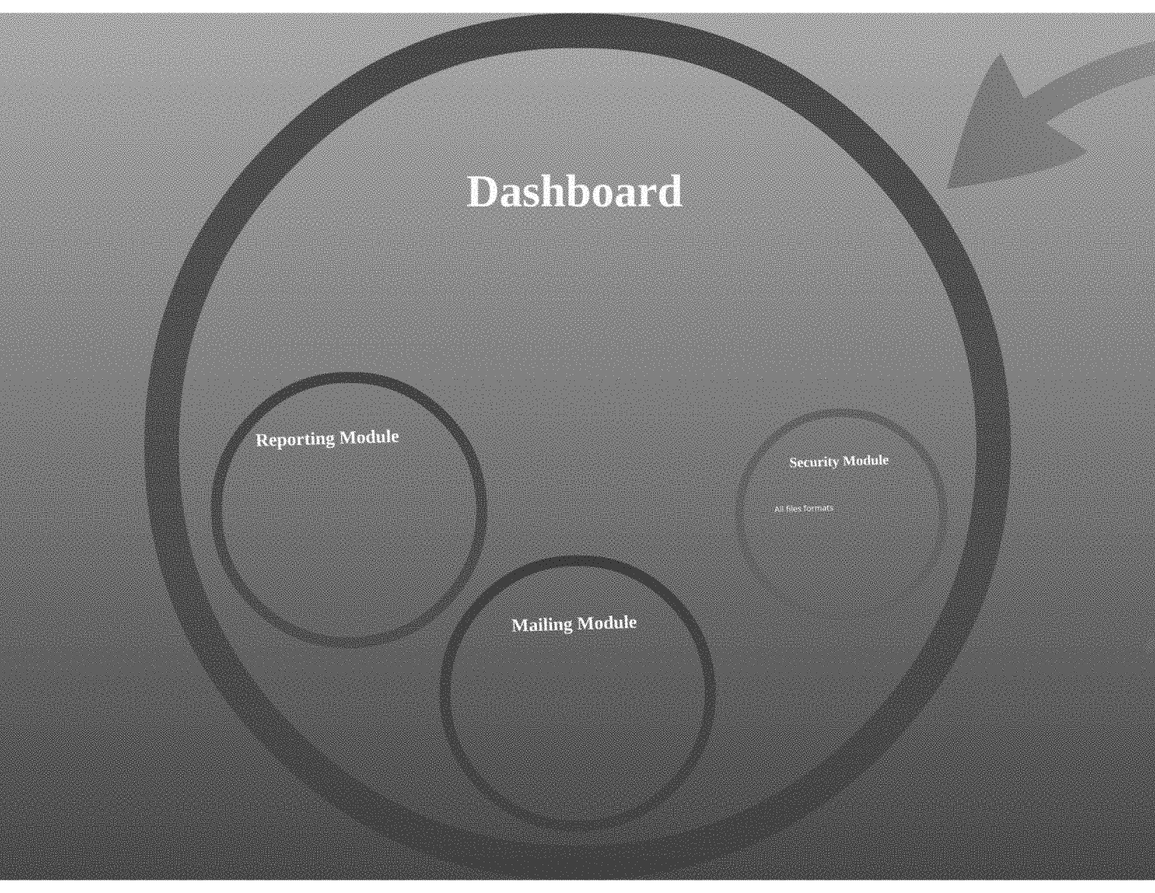

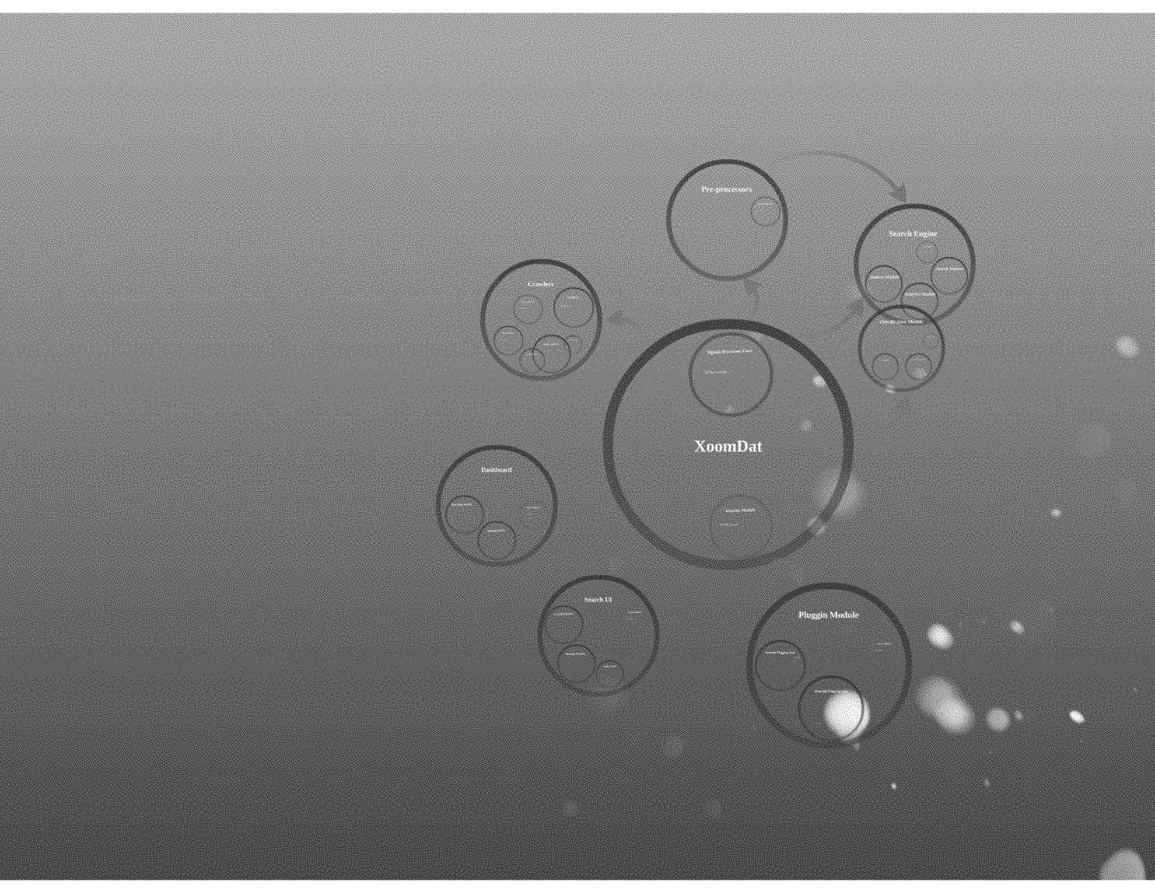

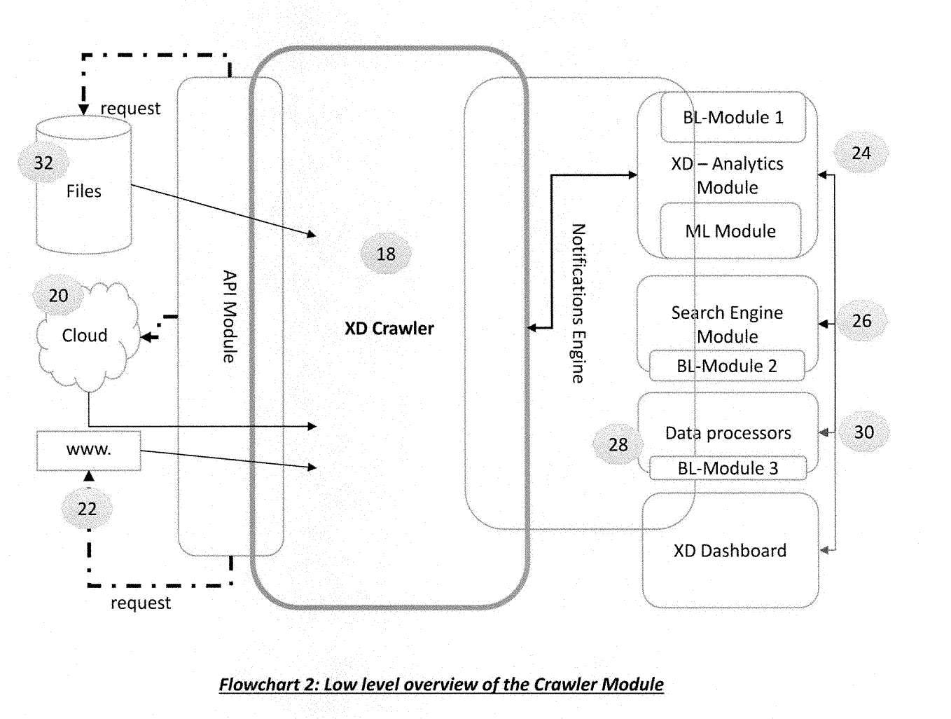

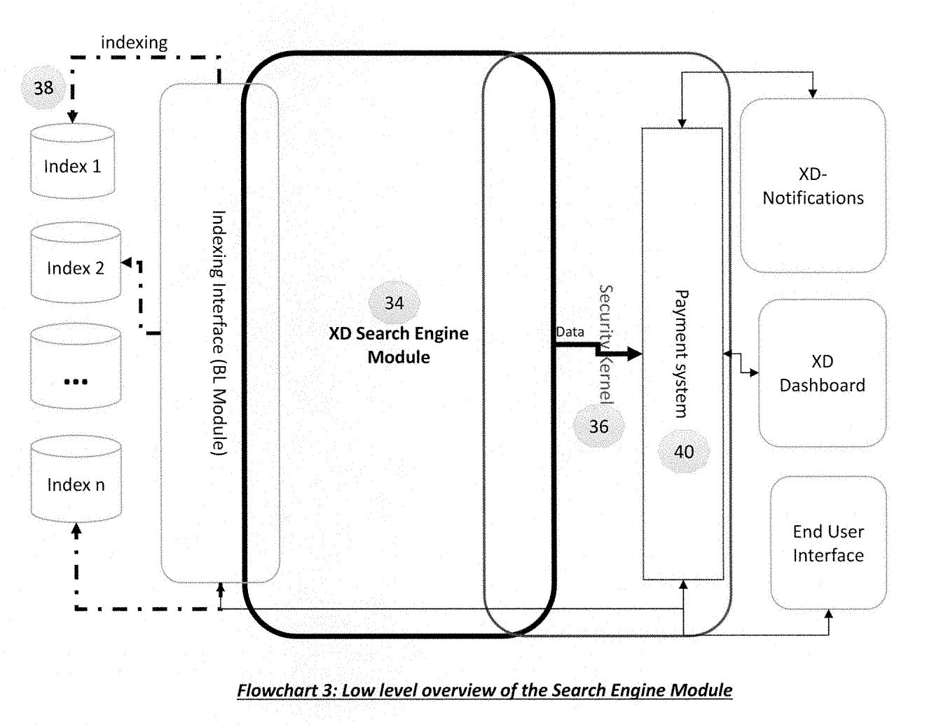

These challenges have been met and are available TODAY with Xoomdat. Based on a revolutionary invention that delivers customizable real-time search, real-time crawl, real-time analytics, real-time dashboards, real-time notifications all within a state-of-the-art security kernel that is future proof. The result is real-time information technology that makes it affordable for small, medium, and large companies to significantly leverage their operations for greater efficiency and bottom line financial performance.

XoomDat's advanced technology (U.S. PTO Patent No. 62/295,140) features a revolutionary technology that delivers tailored end solutions that meet or exceed our customers' real-time data and information system's needs. Some of our main features are:
real-time search
real-time crawl
real-time analytics
real-time dashboards
real-time notifications systems
real-time customizable reports
Unlimited features & plugin expansion
Friendly access to search logic from end-user interface
Customizable & robust security kernel with multi-level policies
User-interfaces out of the box
Spellchecks, synonyms, autocomplete, autocorrect
Internationalization, Geolocations
Advanced filtering, faceting, aggregations, tags
Search & analyze documents, pictures, audio, videos, etc
Web, IOS & Android apps

Our technology has evolved over the last five years and has been field proven by fortune 500 companies and Government agencies, as well as by users in the commercial arena, including 30 customers in France.

### BACKGROUND

### Field of the Invention

The present invention (Xoomdat, also called Searche) is a real-time search technology (software) with the unique ability to find, analyze, process, secure and dispatch in real-time, any type of information, regardless of its location and overall structure.

### Description of the Related Art

The present invention is used to find secured and unsecured data from local and remote resources such as network drives, cloud &remote storages and websites, local files and databases in order to find relevant information regarding the dataset provided as input parameter. Once the information is found by Xoomdat, the technology also automatically processes and analyze the information prior to displaying it to the client. And all of this is done in real-time. This invention features both relevancy search capabilities as well as semantic search capabilities. And such, it is very useful for any domain of application in need for a precise and secured real-time information system.

### SUMMARY

The present invention is used to delivers customizable real-time search. The present invention is also used to delivers customizable real-time crawl. The present invention is also used to delivers customizable real-time analytics, including real-time dashboards and notifications. The present invention is also used to create real-time payment applications. All of the above is done within a powerful security kernel that ensure the on-demand protection of any data within the system, if needed. The result is comprehensive real-time secured information technology that makes it affordable for small, medium, and large companies to significantly leverage their operations for greater efficiency and bottom line financial performance.

This invention features a revolutionary technology that delivers tailored end solutions that meet or exceed our customers' real-time data and information system's needs.

### BRIEF DESCRIPTION OF THE DRAWINGS

Flowchart 1: High Level Overview of the Main Components

This chart illustrates the system at a high-level view, showing how the technology glues its different components together at a high level.
First, new/non-existing data is collected via the real-time crawl component. Herein, we are showing few datasources such as Google, Wall street and Facebook as seen in (10).
As new data is gathered through the real-time crawl platform, it is automatically processed and aggregated to the data used for other components such as the real-time visualization: for visualization, the real-time analytics for reporting and notifications; and the real-time search user interface, allowing end users to perform semantic and relevancy queries and at the same time, have a real-time view of their entire system (12) (14) (16)

Flowchart 2: Low Level Overview of the Crawler Module

On a scheduled and on-demand basis, the search-crawlers (18) crawl both secured and unsecured resources (20) such as network drives, cloud storages and websites to find relevant information regarding the dataset provided as parameter to the crawlers.

(22) shows the request path of the data that we're looking for, outside of the system.

(24) is the module where we incorporate the end-user business logic within our machine learning (ML) system.

(26) is the search Engine module, more detailed in the Flowchart 3.

(28) is the notifications Engine that allows us to send real-time notifications though the entire system and also to the external world.

(30) is the data processor module, allowing us to incorporate extra business logic requirements that are more static or that do not often change over time.

(32) represent local storages for intranet usage

Flowchart 3: Low Level Overview of the Search Engine Module

This FIGURE shows the various internal components that, together, make the search engine platform.

(34) The core search engine includes a Bayesian-like model that we created in order to enable the real-time searching of newly collected data that need aggregation and classification prior to display.

(36) A powerful security kernel that we created in order to secure any data collected, with the ability to restrict access to the field level. For instance, if we consider a place name and address as collected data, the security kernel can restrict access to anything between the name, the street name, the zip code and even the country code. This kernel also has the capability to mask and/or encrypt the data.

(38) The indexing module. This module is very portable and implemented with a distributed architecture in a way that allows us to process the data in parallel, enabling real-time processing capabilities, regardless of the size of data to process. New indexes/deleted are created on the fly as needed and configured both on query time and indexing time, depending on the specific use case.

(40) We created the payment module in order to enable the option to charge access to secured data or provide an online payment platform for data requiring registration such as paid events as for example, conferences, parties, etc. . . . . This payment module comes with a user interface where the owner or approved manager of the data can setup payments options required to access the data.

### DETAILED DESCRIPTION

XoomDat was designed from the ground up with the ability to virtually find any kind of information, regardless of the location of data or its overall structure. On a scheduled and on-demand basis, the search-crawlers crawl both secured and unsecured resources such as network drives, cloud storages and websites to find relevant information regarding the dataset provided as parameter to the crawlers.

A basic implementation of the crawler can A basic implementation of the crawler can be accomplished as follows:

### 1. Web Resources (22)

a. Purge the data graph counter
b. For each data in the input dataset, do the following
   i. if the data needs API or secured access
      Get the API/security key credentials necessary to process the API call (must have already implemented the way API calls should be handled on the provider's API system. Generally, this involves creating specific service API apps on the provider's system
      Construct the API url to use for the API call
   ii. Else (data is publicly accessible)
      Construct the API url to use for the API call
      Perform the API/request call, specifying the returned format for data
   iii. Process the raw data
      Collect the data
      Apply client's heuristics to minimize amount of data collected
      Pre-process (clean) collected data
      Dispatch to Aggregation engine to complete missing information (24)
      Dispatch the new data to the machine learning model for automatic text-classification/categorization (24)
      Dispatch the processed data to the search engine for real-time indexing (26)
      Save metadata of the collected data in the database and log transaction
      Send a notification signal to the notification engine (28)
      Generate a unique Tag representing data collected
         a. Tags are generated based on a specific formula ensuring their relevance based on the url and their uniqueness in our database system. A Tag is generated during data collection in order to optimize filtering capabilities at the user interface
   iv. Dispatch collected & processed data to real-time search engine
   v. Dispatch data to client interfaces
   vi. Repeat the process for each child data requiring API call.

### 2. Local Resources (32)

a. Purge the data graph counter
b. For each folder/file given as input parameter, do the following
   Get the API credentials necessary to access the data
   Construct the API url to use for the API call
   Perform the API/request call with the url, specifying the returned format for data
   Process the raw data as in 1.iii
   Generate a unique Tag representing data collected
   Dispatch collected & processed data to real-time search engine
   Dispatch data to client interfaces
   Repeat process for each child folder/file

### Manual Indexing

This process allows authorized user to refresh the search-engine on-demand via a simple user-interface, without the need to know any programming language. It also allows the authorized user to provide specific indexing rules to the search engine such as, n-grams lengths, synonyms policies, autocomplete/autocorrect policies, etc.

### Scheduled Indexing

This process allows to refresh the search engine on schedule basis, and dispatch the result of the action to the notification engine which in returns, dispatch the summary of the action to the real-time dashboard.

### Chunk Indexing

This process can be done within manual indexing and scheduled indexing. It allows to index a specific chunk of data based on customer-defined rules. A typical example is the chronological indexing (all data modified for the last x minutes since y event occurred)

### Real-Time Indexing

This is another aspect of the uniqueness of this invention. Typical use case, is when the system needs to provide data to the end user, given that the data is not yet known by the system. Through a unique algorithm involving interaction between Crawler module (Flowchart 2:18, the analytics module (Flowchart 2:24), the data processor (Flowchart 2:30), the search module (Flowchart 3: 34) and the security kernel (Flowchart 3:36) we were able to create a real-time craw, index and dispatch functionality that allows the user to find information in real-time, even if the system did not have any prior knowledge of such information. It is all done at search time seamlessly, giving the end user the impression that we had the requested information prior to showing. An implementation of the feature is available to try at: https://www.xoomdatevent.com/

### Real-Time Data Normalization

External API:
   i. We use external API connections to get data from secured websites. Each secured website implement its API connections differently. We created apps for each secured website allowing us to perform a two ways communication.
Internal DBMS:
   i. We use our own internal DBMS as raw indexer for data and data normalization. This internal DBMS also store physical links to customers tickets and user profile, excluding any sort of financial information
Internal API
   i. We use Open Sources libraries and API to assist with dynamic indexing. We've also built our own API that allow our system to sync data with our mobile applications, so that, the same information is streamlined across technologies and programming languages

### Real-Time Notification Engine

We created the real-time notification engine to enable the ability to dispatch any data/event to internal and external real-time consumers such as end-user dashboards, client APIs, etc, This engine automatically adjust the displays by aggregating the new data with the existing data and re-organizing the dataset in real-time. An implementation of the feature is available to try via this real-time crime mapping application for example:

http://www.xoomdat.com/dashboard/crimes/los-angeles/

### Real-Time Dashboard

The core of XoomDat unique power is its ability to collect and dispatch a vast and diverse amount of data in real-time. To avoid the “drinking from a firehose effect”, we also create a real-time dashboard engine, that allows end users to decide the granularity level of the information detail the need to see, as well as the type of information to display in the dashboard

### Real-Time ML Analytics

Another unique power of XoomDat is its ability to perform real-time data analytics and text-classification out of the box, regardless off the amount of data to process. As we get new information, our ML model also creates now data points to improve the accuracy of our prediction models. At the same time, our text-classification engine normalizes the data and directly dispatch it to the search engine. All this is done seamlessly and in real-time, through a unique data orchestration model that we created.

### Payment System

This functionality is available for systems that need to charge a fee prior to exposing the crawled and organized data to their end users. This invention also features a unique machine learning approach that allows Xoomdat to let anyone create and setup payments for any data in our system. However, through our unique technology, only the owner of the data or approved owner is able to activate the functionality, automatically, without any sort of assistance from us. It works as follows at the high level:
Any authenticated user creates from the user interface payment option for the data and specify what data requires payment.
Our system first try to check if the user is the owner of the data or an approved admin
If so, then, enable the payment option in real-time
If not, provide a unique authorization code to the user that should be inserted at the same source (location) where the original data was created
User copies the code over to the source of the original data.
Immediately, our crawler, machine learning module and payment system use the internal algorithm to check for authorization and enable/disable the payment option created

### Plugging Engine

This engine allows for additional expansion of the system with third party plugins without any system downtime (hot-expansion).0

1. Our revolutionary invention is a real-time search and analytics technology that delivers the ability to search for and find any kind of information (local, or remote) accessible over any network or cloud location, and process, analyze, secure and display that information to end users, in real-time, while giving them the ability to incorporate their own business logic in order to enhance precision of the information returned.
